(19) United States
(12) Patent Application Publication
(10) Pub. No.: US 2026/0024789 A1
(43) Pub. Date: Jan. 22, 2026

(54) APPARATUS AND METHOD FOR DETERMINING AIR DISTRIBUTION PERFORMANCE OF A FUEL CELL SYSTEM

(71) Applicants: HYUNDAI MOTOR COMPANY, Seoul (KR); KIA CORPORATION, Seoul (KR)

(72) Inventors: Sun Il Kim, Hwaseong-si (KR); Bong Hyun Jung, Hwaseong-si (KR)

(73) Assignees: HYUNDAI MOTOR COMPANY, Seoul (KR); KIA CORPORATION, Seoul (KR)

(21) Appl. No.: 19/098,656

(22) Filed: Apr. 2, 2025

(30) Foreign Application Priority Data
Jul. 19, 2024 (KR) 10-2024-0095565

(51) Int. Cl. H01M 8/0438; H01M 8/04089; H01M 8/04492; H01M 8/04664; H01M 8/04746; H01M 8/249

(52) U.S. Cl. CPC H01M 8/04395; H01M 8/04089; H01M 8/04507; H01M 8/04679; H01M 8/04753; H01M 8/249

(57) ABSTRACT

An apparatus and a method are for determining air distribution performance of a fuel cell system. The apparatus includes: an air cut off valve connected to a downstream side of an air compressor and supplied with first air discharged from the air compressor; a first fuel cell stack connected to the air cut off valve through a first air path and supplied with second air through the first air path; a second fuel cell stack connected to the air cut off valve through a second air path and supplied with third air through the second air path; and a controller. The controller determines a ratio between a flow rate of the third air and a flow rate of the second air based on absolute humidity values of the first, second, and the third air, and determines air distribution performance between the second fuel cell stack and the first fuel cell stack based on the ratio.

### CROSS-REFERENCE TO RELATED APPLICATION

This application claims, under 35 U.S.C. § 119 (a), the benefit of and priority to Korean Patent Application No. 10-2024-0095565 filed on Jul. 19, 2024, the entire contents of which are incorporated herein by reference.

### TECHNICAL FIELD

The present disclosure relates to an apparatus and a method for determining air distribution performance of a fuel cell system, and more particularly, to an apparatus and a method for determining air distribution performance of a fuel cell system having a plurality of fuel cell stacks.

### BACKGROUND

In general, a fuel cell stack refers to a device that generates electrical energy by electrochemically reacting fuel and oxidizer. The fuel cell stack is continuously supplied with fuel and oxygen to continuously generate electrical energy.

The fuel cell system includes a fuel supply system for supplying fuel to the fuel cell stack and an air supply system for supplying air to the fuel cell stack.

The air supply system includes an air compressor for supplying air necessary for the electrochemical reaction in the fuel cell stack at appropriate flow rate and pressure, a humidifier for humidifying the air supplied to the fuel cell stack, a pressure valve for controlling air pressure inside the fuel cell stack, and an air cut off valve for adjusting air flow into and out of the fuel cell stack when the fuel cell stack is not in operation.

The air cut off valve allows the air to flow into and out of the fuel cell stack when the fuel cell stack is in operation. In addition, in order to improve durability of the fuel cell stack, the air cut off valve blocks the air flow into and out of the fuel cell stack when the fuel cell stack is not in operation.

The above information disclosed in this Background section is only to enhance understanding of the background of the disclosure. Therefore, the Background section may contain information that does not form the prior art that is already known to a person of ordinary skill in the art.

### SUMMARY

In general, a fuel cell system employs a single air compressor to supply air to two fuel cell stacks.

FIG. 1 shows a typical fuel cell stack manifold. FIG. 2 is a side cut away view of the manifold seen from A-A in FIG. 1. FIG. 3 shows a fuel cell stack casing with which the manifold is combined.

As shown in FIGS. 1 and 2, a typical fuel cell stack manifold 1 includes an air inlet 2 and an air outlet 3. The manifold 1 includes a first air path 4 and a second air path 5 connected to one air inlet 2. Although not shown, each of the air inlet 2 and the air outlet 3 is opened and closed by an air cut off valve.

When the fuel cell stack is operated, air passing through the air cut off valve is supplied to a first fuel cell stack 6 and a second fuel cell stack 7 (see FIG. 3) through the air inlet 2. Some of the air supplied to the air inlet 2 is supplied to the first fuel cell stack 6 through the first air path 4. The remainder of the air supplied to the air inlet 2 is supplied to the second fuel cell stack 7 through the second air path 5. In addition, air that remains after being used for electrochemical reaction, in the air that has been introduced into the inside of the first and second fuel cell stacks 6 and 7, is discharged to the outside through the air outlet 3.

Referring to FIG. 3, the first fuel cell stack 6 is stacked on the top of the second fuel cell stack 7 and is accommodated in a casing 8 together with the second fuel cell stack 7. The manifold 1 is connected to an end portion of the casing 8 so as to supply air to the first fuel cell stack 6 and the second fuel cell stack 7.

There may occur a problem that the air supplied to the air inlet 2 of the manifold 1 is not evenly distributed to the first fuel cell stack 6 and the second fuel cell stack 7. The reason why this problem occurs is that it is difficult to measure the flow rates of the air supplied to the first fuel cell stack 6 and the second fuel cell stack 7. Thus, a method for estimating the flow rates of the air supplied to the first fuel cell stack 6 and the second fuel cell stack 7 and designing the fuel cell system based on the estimated flow rates is used.

When the air flow rates in the first fuel cell stack and the second fuel cell stack are different from each other, the performance of the fuel cell stack deteriorates, and it becomes difficult to implement a voltage control strategy for the fuel cell stacks.

Accordingly, in general, a flow meter has been used to measure the flow rate of the air supplied to the first fuel cell stack and the flow rate of the air supplied to the second fuel cell stack. However, in this case, a separate space for providing the flow meter is necessary, and measurement accuracy of the flow meter may decrease due to moisture contained in the air. Further, it is difficult to measure the air flow rate under various operating conditions of the fuel cell stack by using the flow meter due to the limitation of a measurable flow rate range.

The present disclosure has been made in an effort to solve the above-described problems associated with the prior art. An object of the present disclosure is to provide an apparatus and a method for determining air distribution performance of a fuel cell system, capable of accurately determining air distribution performance for a plurality of fuel cell stacks that receive air from a single air compressor.

The objects of the present disclosure are not limited to the above-mentioned objects. Other objects of the present disclosure not mentioned herein should be more clearly understood by those having ordinary skill in the art to which the present disclosure belongs from the description below.

In one aspect, the present disclosure provides an apparatus for determining air distribution performance of a fuel cell system. The apparatus includes: an air cut off valve that is connected to a downstream side of an air compressor and is supplied with first air discharged from the air compressor; a first fuel cell stack that is connected to the air cut off valve through a first air path and is supplied with second air through the first air path; a second fuel cell stack that is connected to the air cut off valve through a second air path and is supplied with third air through the second air path; and a controller. The controller is configured to determine a ratio between a flow rate of the third air and a flow rate of the second air based on absolute humidity values of the first air, the second air, and the third air, and to determine air distribution performance between the second fuel cell stack and the first fuel cell stack based on the ratio.

In an embodiment, the controller may be further configured to: determine a first absolute humidity of the first air based on a first dew point and a first pressure measured on an upstream side of the air cut off valve; determine a second absolute humidity of the second air based on a second dew point and a second pressure measured in the first air path; and determine a third absolute humidity of the third air based on a third dew point and a third pressure measured in the second air path.

In another embodiment, when the ratio between the flow rate of the third air and the flow rate of the second air is equal to or greater than a set minimum value and is equal to or smaller than a set maximum value, the controller may determine that the air distribution performance between the first fuel cell stack and the second fuel cell stack is not defective. When the ratio between the flow rate of the third air and the flow rate of the second air is smaller than the set minimum value or greater than the set maximum value, the controller may determine that the air distribution performance between the first fuel cell stack and the second fuel cell stack is defective.

In still another embodiment, when a difference value between the flow rate of the second air and the flow rate of the third air is equal to or greater than a set threshold, the controller may determine that the air distribution performance between the first fuel cell stack and the second fuel cell stack is defective. When the difference value between the flow rate of the second air and the flow rate of the third air is smaller than the set threshold, the controller may determine that the air distribution performance between the first fuel cell stack and the second fuel cell stack is not defective.

In yet another embodiment, the flow rate of the second air and the flow rate of the third air may be determined based on the first absolute humidity, the second absolute humidity, the third absolute humidity, and the flow rate of the first air. In still yet another embodiment, when it is determined that (i.e., in response to determining that) the air distribution performance between the first fuel cell stack and the second fuel cell stack is defective, the controller may increase the flow rate of the first air through the air compressor.

In a further embodiment, after increasing the flow rate of the first air, the controller may re-determine the difference value between the flow rate of the second air and the flow rate of the third air and may determine, when the re-determined difference value is smaller than the threshold, that a cause of the defective air distribution performance between the first fuel cell stack and the second fuel cell stack is flooding that has occurred in at least one of the first fuel cell stack or the second fuel cell stack.

In another further embodiment, when the re-determined difference value is equal to or greater than the threshold, the controller may determine that the cause of the defective air distribution performance between the first fuel cell stack and the second fuel cell stack is not the flooding.

In still another further embodiment, when the re-determined difference value is equal to or greater than the threshold, the controller may turn on a warning light to warn of the defective air distribution performance between the first fuel cell stack and the second fuel cell stack.

In another aspect, the present disclosure provides a method for determining air distribution performance of a fuel cell system. The method includes: determining, by a controller, a first absolute humidity of first air supplied to an air cut off valve disposed on a downstream side of an air compressor: determining, by the controller, a second absolute humidity of second air supplied to a first fuel cell stack connected to the air cut off valve through a first air path; determining, by the controller, a third absolute humidity of third air supplied to a second fuel cell stack connected to the air cut off valve through a second air path; determining, by the controller, a ratio between the flow rate of the third air and the flow rate of the second air based on absolute humidity values of the first air, the second air, and the third air (e.g., the first absolute humidity of the first air, the second absolute humanity of the second air, and the second absolute humidity of the third air); and determining, by the controller, air distribution performance between the second fuel cell stack and the first fuel cell stack based on the ratio.

Other aspects and embodiments of the disclosure are discussed below.

### BRIEF DESCRIPTION OF THE DRAWINGS

The above and other features of the present disclosure are described in detail with reference to certain embodiments thereof illustrated the accompanying drawings, which are given hereinafter by way of illustration only, and thus are not limitative of the present disclosure, and wherein:

FIG. 1 is a diagram showing a typical fuel cell stack manifold;

FIG. 2 is a side cut away view of the manifold seen from A-A in FIG. 1;

FIG. 3 is a diagram showing a fuel cell stack casing with which the manifold in FIG. 1 is combined;

FIGS. 4 and 5 are diagrams showing an apparatus for determining air distribution performance of a fuel cell system according to an embodiment of the present disclosure;

FIG. 6 is a flowchart showing a method for determining air distribution performance of a fuel cell system according to an embodiment of the present disclosure; and

FIG. 7 is a flowchart showing a method for determining a cause of defective air distribution performance of a fuel cell system according to an embodiment of the present disclosure.

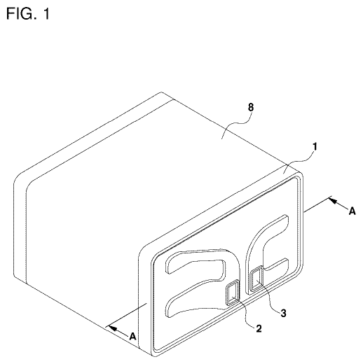

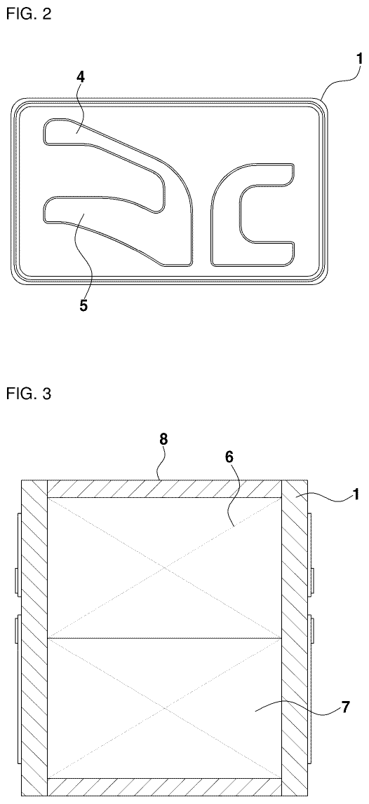

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, the same reference numbers refer to the same or equivalent parts of the present disclosure throughout the several figures of the drawings.

### DETAILED DESCRIPTION

Hereinafter, reference is made in detail to various embodiments of the present disclosure. Examples of various embodiments are illustrated in the accompanying drawings and described below. While the disclosure is described in conjunction with certain embodiments, it should be understood that the present description is not intended to limit the disclosure to the embodiments. On the contrary, the disclosure is intended to cover the disclosed embodiments, as well as various alternatives, modifications, equivalents, and other embodiments, within the spirit and scope of the disclosure as defined by the appended claims.

It should be understood that, although terms such as “first”, “second”, and the like may be used herein to describe various elements, these elements should not be limited by these terms. These terms are only used to distinguish one element from another. For example, a first element may be termed a second element, and, similarly, a second element may be termed a first element, without departing from the scope of the embodiments of the present disclosure.

Further, in this specification, terms such as “upstream side” and “downstream side” are used to describe directions of air flow unless otherwise specified. Furthermore, when a unit, part, module, component, controller, device, element, apparatus, or the like of the present disclosure is described as having a purpose or performing an operation, function, or the like, the unit, part, module, component, controller, device, element, apparatus, or the like should be considered herein as being “configured to” meet that purpose or to perform that operation or function. Each unit, part, module, component, controller, device, element, apparatus, and the like (i.e., an apparatus) may separately embody or be included with a processor and a memory, such as a non-transitory computer readable media, as part of the apparatus. In addition, in the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases. Throughout the present disclosure and claims, where one aspect is said to occur “when” another aspect of the disclosure occurs or has occurred, it can be said that the one aspect occurs “in response to” the other aspect occurring or having occurred.

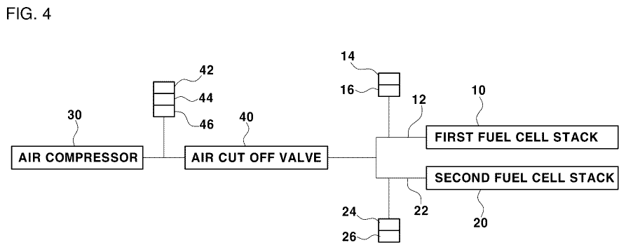

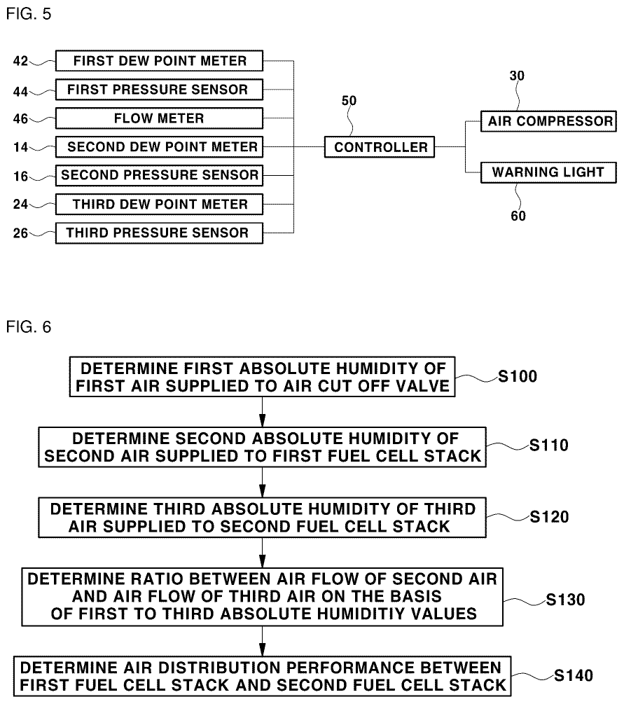

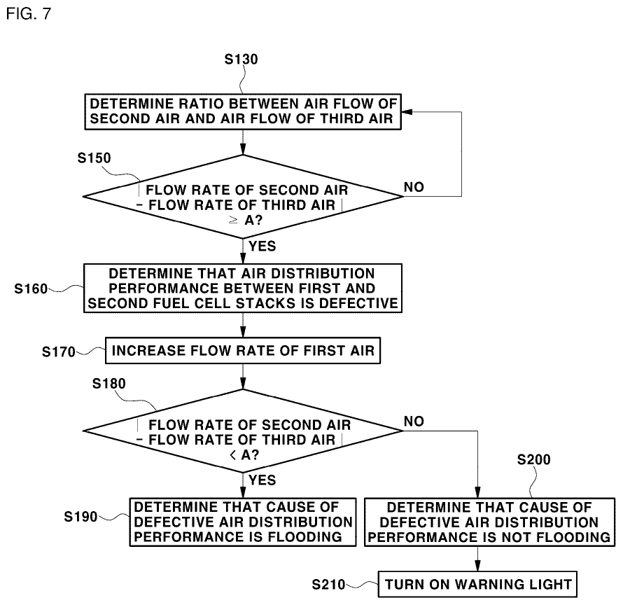

FIGS. 4 and 5 show an apparatus for determining air distribution performance of a fuel cell system according to an embodiment of the present disclosure. FIG. 6 shows a method for determining air distribution performance of a fuel cell system according to an embodiment of the present disclosure. FIG. 7 shows a method for determining a cause of defective air distribution performance of a fuel cell system according to an embodiment of the present disclosure.

As shown in FIG. 4, the apparatus for determining air distribution performance of the fuel cell system according to an embodiment of the present disclosure uses dew point meters 14, 24, and 42 and pressure sensors 16, 26, and 44 to determine air distribution performance for a first fuel cell stack 10 and a second fuel cell stack 20.

The first fuel cell stack 10 and the second fuel cell stack 20 are supplied with air necessary for an electrochemical reaction from a single air compressor 30 provided in the fuel cell system. The air pressurized and discharged from the air compressor 30 is supplied to the first fuel cell stack 10 and the second fuel cell stack 20 through an air cut off valve 40 connected to a downstream side of the air compressor 30.

Although not shown, a humidifier for humidifying the air supplied to the fuel cell stacks 10 and 20 may be provided between the downstream side of the air compressor 30 and an upstream side of the air cut off valve 40.

The first dew point meter 42 and the first pressure sensor 44 are connected to and provided on the upstream side of the air cut off valve 40. The first dew point meter 42 is configured to measure a dew point of air (i.e., first air) discharged from the air compressor 30 and supplied to the upstream side of the air cut off valve 40. The first pressure sensor 44 is configured to measure the pressure of the first air.

The second dew point meter 14 and the second pressure sensor 16 are provided on a first air path 12 connected to a downstream side of the air cut off valve 40. The second dew point meter 14 is configured to measure a dew point of air (i.e., second air) supplied to the first fuel cell stack 10 through the first air path 12. The second pressure sensor 16 is configured to measure the pressure of the second air.

The third dew point meter 24 and the third pressure sensor 26 are provided on a second air path 22 connected to the downstream side of the air cut off valve 40. The third dew point meter 24 is configured to measure a dew point of air (i.e., third air) supplied to the second fuel cell stack 20 through the second air path 22. The third pressure sensor 26 is configured to measure the pressure of the third air.

The first air path 12 and second air path 22 are individually connected to the downstream side of the air cut off valve 40. The downstream side of the air cut off valve 40 may be connected to an inlet (i.e., upstream side) of the first air path 12 and an inlet (i.e., upstream side) of the second air path 22 to allow air flow. An outlet (i.e., downstream side) of the first air path 12 may be connected to the air inlet of the first fuel cell stack 10, and an outlet (i.e., downstream side) of the second air path 22 may be connected to the air inlet of the second fuel cell stack 20.

In other words, the first fuel cell stack 10 is connected to the downstream side of the air cut off valve 40 through the first air path 12. Also, the second fuel cell stack 20 is connected to the downstream side of the air cut off valve 40 through the second air path 22.

Accordingly, the air (i.e., first air) discharged from the air compressor 30 and passing through the air cut off valve 40 is distributed to the first fuel cell stack 10 and the second fuel cell stack 20 through the first air path 12 and the second air path 22.

As shown in FIG. 5, dew point data measured by the dew point meters 14, 24, and 42 and pressure data measured by the pressure sensor 16, 26, and 44 may be transmitted to a controller 50 in real time. The controller 50 may be a fuel cell controller for performing overall control of the fuel cell system.

Further, a flow meter 46 may be provided on the upstream side of the air cut off valve 40. The flow meter 46 is configured to measure the flow rate of the first air supplied to the upstream side of the air cut off valve 40.

The first fuel cell stack 10 and the second fuel cell stack 20 are electrically connected to each other in series or in parallel.

The controller 50 is configured to determine a ratio between the flow rate of the third air and the flow rate of the second air (i.e., air distribution ratio) based on absolute humidity values of the first air, second air, and third air. The absolute humidity of the first air (i.e., a first absolute humidity) may be calculated using Equation 1, the absolute humidity of the second air (i.e., a second absolute humidity) may be calculated using Equation 2, and the absolute humidity of the third air (i.e., a third absolute humidity) may be calculated using Equation 3.

X=m_{w1}/mₐ₁=0.622×Pₛₐₜ(T₁)/{P₁−Pₛₐₜ(T₁)} [Equation 1]

Y=m_{w2}/mₐ₂=0.622×Pₛₐₜ(T₂)/{P₂−Pₛₐₜ(T₂)} [Equation 2]

Z=m_{w3}/mₐ₃=0.622×Pₛₐₜ(T₃)/{P₃−Pₛₐₜ(T₃)} [Equation 3]

In Equations 1-3, X represents the first absolute humidity, Y represents the second absolute humidity, Z represents the third absolute humidity, T₁ represents a dew point of the first air (i.e., a first dew point), P₁ represents a pressure of the first air (i.e., a first pressure), T₂ represents a dew point of the second air (i.e., a second dew point), P₂ represents a pressure of the second air (i.e., a second pressure), T₃ represents a dew point of the third air (i.e., a third dew point), and P₃ represents a pressure of the third air (i.e., a third pressure). In addition, Pₛₐₜ (T₁) represents a saturated vapor pressure (i.e., a maximum vapor amount) at T₁, Pₛₐₜ (T₂) represents a saturated vapor pressure at T₂, and Pₛₐₜ (T₃) represents a saturated vapor pressure at T₃. Further, mat represents a flow rate of the first air (i.e., a first flow rate), m_{w1} represents a vapor amount of the first air (i.e., a first vapor amount), mₐ₂ represents a flow rate of the second air (i.e., a second flow rate), m_{w2} represents a vapor amount of the second air (i.e., a second vapor amount), mₐ₃ represents a flow rate of the third air (i.e., a third flow rate), and m_{w3} represents a vapor amount of the third air (i.e., a third vapor amount). In Equations 1-3, 0.622 is a value obtained by dividing a vapor molecular weight by an air molecular weight.

As shown in Equation 1, the controller 50 calculates and determines the first absolute humidity (X) of the first air based on the first dew point (T₁) and the first pressure (P₁) measured on the upstream side of the air cut off valve 40 (S100 of FIG. 6).

As shown in Equation 2, the controller 50 calculates and determines the second absolute humidity (Y) of the second air based on the second dew point (T₂) and the second pressure (P₂) measured on the first air path 12 (S110 of FIG. 6).

As shown in Equation 3, the controller 50 calculates and determines the third absolute humidity (Z) of the third air based on the third dew point (T₃) and the third pressure (P₃) measured on the second air path 22 (S120 of FIG. 6).

In addition, the first flow rate (mₐ₁) is the sum of the second flow rate (mₐ₂) and the third flow rate (mₐ₃) (see Equation 4), and the first vapor amount (m_{w1}) is the sum of the second vapor amount (m_{w2}) and the third vapor amount (m_{w3}) (see Equation 5).

mₐ₁=mₐ₂+mₐ₃ [Equation 4]

m_{w1}=m_{w2}+m_{w3} [Equation 5]

Based on Equations 1 to 5, Equations 6 to 10 may be derived.

m_{w1}=mₐ₂×y+mₐ₃×Z

=(mₐ₁−mₐ₃)×Y+mₐ₃×Z

=mₐ₁×Y−mₐ₃×Y+mₐ₃×Z

=mₐ₁×y+(Z−Y)×mₐ₃ [Equation 6]

mₐ₃=(m_{w1}−mₐ₁×Y)/(Z−Y) [Equation 7]

mₐ₂=mₐ₁−mₐ₃=mₐ₁−(m_{w1}-mₐ₁×Y)/(Z−Y) [Equation 8]

mₐ₃=(m_{w1}−mₐ₁×Y)/(Z−Y)

=(mₐ₁×X−mₐ₁×Y)/(Z−Y)

=mₐ₁×(X−Y)/(Z−Y) [Equation 9]

mₑ₂=mₐ₁−(m_{w1}−mₐ₁×Y)/(Z−Y)

=mₐ₁−(mₐ₁×X−mₐ₁×Y)/(Z−Y)

=mₐ₁−mₐ₁×(X−Y)/(Z−Y)

=mₐ₁×{1−(X−Y)/(Z−Y)}[Equation10]

Based on Equations 9 and 10, Equation 11 may be derived. Through Equation 11, a ratio (mₐ₃:mₐ₂) between the flow rate (mₐ₃) of the third air supplied to the second fuel cell stack 20 and the flow rate (mₐ₂) of the second air supplied to the first fuel cell stack 10 may be calculated and determined. In other words, the air distribution ratio (mₐ₃:mₐ₂) between the second fuel cell stack 20 and the first fuel cell stack 10 may be determined according to Equation 11. The ratio (mₐ₃:mₐ₂) may also be expressed as a fractional value (mₐ₃/mₐ₂).

mₐ₃:mₐ₂=(X−Y)/(Z−Y):1−(X−Y)/(Z−Y) [Equation 11]

The controller 50 may determine the ratio (mₐ₃:mₐ₂) between the flow rate (mₐ₃) of the third air and the flow rate (mₐ₂) of the second air using Equation 11 (see S130 of FIG. 6). The controller 50 may also determine the air distribution performance between the first fuel cell stack 10 and the second fuel cell stack 20 based on the ratio (mₐ₃:mₐ₂) (see S140 of FIG. 6).

In other words, the controller 50 determines the ratio (mₐ₃:mₐ₂) between the flow rate of the third air (mₐ₃) and the flow rate of the second air (mₐ₂) based on the first absolute humidity (X), the second absolute humidity (Y), and the third absolute humidity (Z) (see S130 of FIG. 6).

Even when the value of the flow rate (mₐ₁) of the first air cannot be measured, it is possible to calculate and determine the air distribution ratio (mₐ₃:mₐ₂) between the second fuel cell stack 20 and the first fuel cell stack 10 using Equation 11.

In addition, when the flow rate (mₐ₁) value of the first air can be measured, it is possible to calculate and determine both the flow rate (mₐ₂) value of the second air supplied to the first fuel cell stack 10 and the flow rate (mₐ₃) value of the third air supplied to the second fuel cell stack 20.

The controller 50 may determine that the air distribution performance between the first fuel cell stack 10 and the second fuel cell stack 20 is not defective when the ratio (mₐ₃/mₐ₂) between the flow rate (mₐ₃) of the third air and the flow rate (mₐ₂) of the second air is equal to or greater than a set minimum value and is equal to or smaller than a set maximum value. Additionally, the controller 50 may determine that the air distribution performance between the first fuel cell stack 10 and the second fuel cell stack 20 is defective when the ratio (mₐ₃/mₐ₂) is smaller than the minimum value or is greater than the maximum value.

On the other hand, after determining the ratio (mₐ₃:mₐ₂) between the flow rate (mₐ₃) of the third air and the flow rate (mₐ₂) of the second air (see S130 of FIG. 6), the controller 50 may calculate and determine the flow rate (mₐ₂) of the second air and the flow rate (mₐ₃) of the third air using the flow rate (mₐ₁) value of the first air. Referring to Equations 9 and 10, the flow rate (mₐ₂) of the second air and the flow rate (mₐ₃) of the third air are calculated and determined based on the flow rate (mₐ₁) of the first air supplied to the upstream side of the air cut off valve 40, the first absolute humidity (X), the second absolute humidity (Y), and the third absolute humidity (Z).

Referring to FIG. 7, the controller 50 calculates a difference value (|mₐ₂−mₐ₃|) between the flow rate of the second air (mₐ₂) and the flow rate of the third air (mₐ₃) and compares the difference value (|mₐ₂−mₐ₃|) with a set threshold (A) (S150). As a result of the comparison, when the difference value (|mₐ₂−mₐ₃|) is smaller than the threshold (A), the controller 50 may determine that the air distribution performance between the first fuel cell stack 10 and the second fuel cell stack 20 is not defective and may execute step S130 again. Further, when the difference value (|mₐ₂−mₐ₃|) is equal to or greater than the threshold (A), the controller 50 may determine that the air distribution performance between the first fuel cell stack 10 and the second fuel cell stack 20 is defective (S160).

When the air distribution performance between the fuel cell stacks 10 and 20 is defective, at least one process among several processes for improving the air distribution performance may be performed. For example, in order to reduce moisture in the fuel cell stacks 10 and 20, the controller 50 may increase the flow rate (mₐ₁) of the first air compared with a current flow rate (i.e., real-time flow rate) (S170). The current flow rate may refer to the flow rate of air supplied to the upstream side of the air cut off valve 40 at a time when the air distribution performance between the fuel cell stacks 10 and 20 is determined to be defective.

In order to increase the flow rate (mₐ₁) of the first air, the controller 50 may increase an operating speed of the air compressor 30. The air compressor 30 may increase the flow rate (mat) of the first air so as to discharge the moisture inside the fuel cell stacks 10 and 20 to the outside (S170).

Then, the controller 50 re-determines the flow rate (mₐ₂) of the second air and the flow rate (mₐ₃) of the third air, and re-determines the difference value (|mₐ₂−mₐ₃|) between the flow rate (mₐ₂) of the second air and the flow rate (mₐ₃) of the third air. The controller 50 re-compares the re-determined difference value (|mₐ₂−mₐ₃|) with the threshold (A) (S180). When the re-determined difference value (|mₐ₂−mₐ₃|) is smaller than the threshold (A), the controller 50 may determine that the cause of deterioration of the air distribution performance between the fuel cell stacks 10 and 20 is flooding (S190).

When the flow rate (mₐ₁) of the first air increases in a state where the flooding occurs inside at least one of the fuel cell stacks 10 and 20, the moisture inside the fuel cell stacks 10 and 20 may be discharged to the outside and reduced. Thus, it is possible to solve the flooding problem, thereby improving the deterioration and defect of the air distribution performance between the fuel cell stacks 10 and 20 due to the flooding.

The fact that the difference value (|mₐ₂−mₐ₃|) between the flow rate of the second air (mₐ₂) and the flow rate of the third air (mₐ₃) decreases below the threshold (A) after the flow rate (mₐ₁) of the first air increases in step S170 may mean that the cause of the defective air distribution performance between the fuel cell stacks 10 and 20 is flooding.

Therefore, as a result of the re-comparison of the difference value (|mₐ₂−mₐ₃|) and the threshold (A) in step S180, when the difference value (|mₐ₂−mₐ₃|) is smaller than the threshold (A), the controller 50 may determine that the cause of deterioration and defect of the air distribution performance between the fuel cell stacks 10 and 20 is the flooding that has occurred in at least one of the fuel cell stacks 10 and 20 (S190).

Although not shown, each of the first fuel cell stack 10 and the second fuel cell stack 20 includes a plurality of unit cells (not shown) for generating electricity. The unit cell generates electricity through an electrochemical reaction of fuel and oxidizer. The unit cell also generates heat and water as reaction byproducts.

In general, fuel cell stacks achieve performance enhancement by maintaining appropriate moisture within unit cells, but excessive moisture within the unit cells increases the amount of liquid moisture (i.e., water) to cause flooding of the fuel cell stacks. The flooding causes decrease in the performance and durability of the fuel cell stacks.

In addition, when the difference value (|mₐ₂−mₐ₃|) is equal to or greater than the threshold (A) in step S180, the controller 50 determines that the cause of the defective air distribution performance between the fuel cell stacks 10 and 20 is not the flooding (S200).

When it is determined that the cause of the defective air distribution performance between the fuel cell stacks 10 and 20 is not flooding, the controller 50 turns on a warning light 60 to induce inspection of the fuel cell system. In other words, when the difference value (|mₐ₂−mₐ₃|) is equal to or greater than the threshold (A) in step S180, the controller 50 turns on the warning light 60 (S210).

The warning light 60 is provided to warn of the defect of the air distribution performance between the fuel cell stacks 10 and 20 or to induce inspection of the air distribution performance between the fuel cell stacks 10 and 20. For example, the warning light 60 may be an indicator provided in a fuel cell vehicle equipped with the first fuel cell stack 10 and the second fuel cell stack 20.

The warning light 60 may induce inspection of the air distribution performance between the fuel cell stacks 10 and 20 and inspection of fuel cell system failures during turn-on. In this way, by turning on the warning light 60, it is possible to specifically confirm the cause of the deterioration of the air distribution performance between the fuel cell stacks 10 and 20 through inspection of the air distribution performance between the fuel cell stacks 10 and 20 or inspection of the fuel cell system.

Further, the threshold (A) may be set in advance through a test. The threshold (A) may vary according to the flow rate of the first air supplied to the upstream side of the air cut off valve 40 through the air compressor 30.

Further, the air cut off valve 40 is configured to selectively block the flow of air supplied to the fuel cell stacks 10 and 20 and the flow of air discharged from the fuel cell stacks 10 and 20. The air cut off valve 40 operates in an open mode when the fuel cell stacks 10 and 20 are in operation, and operates in a closed mode when the fuel cell stacks 10 and 20 are not in operation.

According to embodiments of the present disclosure, the following effects can be achieved.

First, the ratio between the flow rate of air supplied to the first fuel cell stack and the flow rate of air supplied to the second fuel cell stack can be accurately determined, thereby accurately diagnosing the air distribution performance of the fuel cell system.

Second, it is possible to confirm the cause of defective air distribution performance through air distribution performance diagnosis of the fuel cell system and eliminate the cause. Thus, it is possible to improve the air distribution performance of the fuel cell system and prevent conventional problems that may occur due to the defective air distribution performance.

The effects of the present disclosure are not limited the present description. Other effects of the present disclosure not mentioned herein should be clearly understood by those having ordinary skill in the art to which the present disclosure belongs from the above description.

The technical concepts of the present disclosure have been described in detail with reference to embodiments thereof. However, it should be appreciated by those having ordinary skill in the art that changes may be made in these embodiments without departing from the principles and spirit of the disclosure, the scope of which is defined in the appended claims and their equivalents.

What is claimed is:

1. An apparatus for determining air distribution performance of a fuel cell system, the apparatus comprising:
an air cut off valve connected to a downstream side of an air compressor and supplied with first air discharged from the air compressor;
a first fuel cell stack connected to the air cut off valve through a first air path and supplied with second air through the first air path;
a second fuel cell stack connected to the air cut off valve through a second air path and is supplied with third air through the second air path; and
a controller configured to
determine a ratio between a flow rate of the third air and a flow rate of the second air based on absolute humidity values of the first air, the second air, and the third air, and
determine air distribution performance between the second fuel cell stack and the first fuel cell stack based on the ratio.

2. The apparatus according to claim 1, wherein the controller is further configured to:
determine a first absolute humidity of the first air based on a first dew point and a first pressure measured on an upstream side of the air cut off valve;
determine a second absolute humidity of the second air based on a second dew point and a second pressure measured in the first air path; and
determine a third absolute humidity of the third air based on a third dew point and a third pressure measured in the second air path.

3. The apparatus according to claim 2, wherein the flow rate of the second air and the flow rate of the third air are determined based on the first absolute humidity, the second absolute humidity, the third absolute humidity, and a flow rate of the first air.

4. The apparatus according to claim 1, wherein:
when the ratio between the flow rate of the third air and the flow rate of the second air is equal to or greater than a set minimum value and is equal to or smaller than a set maximum value, the controller is further configured to determine that the air distribution performance between the first fuel cell stack and the second fuel cell stack is not defective; and
when the ratio between the flow rate of the third air and the flow rate of the second air is smaller than the set minimum value or greater than the set maximum value, the controller is further configured to determine that the air distribution performance between the first fuel cell stack and the second fuel cell stack is defective.

5. The apparatus according to claim 1, wherein:
when a difference value between the flow rate of the second air and the flow rate of the third air is equal to or greater than a set threshold, the controller is further configured to determine that the air distribution performance between the first fuel cell stack and the second fuel cell stack is defective; and
when the difference value between the flow rate of the second air and the flow rate of the third air is smaller than the set threshold, the controller is further configured to determine that the air distribution performance between the first fuel cell stack and the second fuel cell stack is not defective.

6. The apparatus according to claim 1, wherein, in response to determining that air distribution to the first fuel cell stack and the second fuel cell stack is defective, the controller is further configured to increase the flow rate of the first air through the air compressor.

7. The apparatus according to claim 6, wherein, after increasing the flow rate of the first air, the controller is further configured to:
re-determine a difference value between the flow rate of the second air and the flow rate of the third air; and
determine, when the re-determined difference value is smaller than a threshold, that a cause of a defective air distribution performance between the first fuel cell stack and the second fuel cell stack is flooding that has occurred in at least one of the first fuel cell stack or the second fuel cell stack.

8. The apparatus according to claim 7, wherein, when the re-determined difference value is equal to or greater than the threshold, the controller is further configured to determine that the cause of the defective air distribution performance between the first fuel cell stack and the second fuel cell stack is not the flooding.

9. The apparatus according to claim 7, wherein, when the re-determined difference value is equal to or greater than the threshold, the controller is further configured to turn on a warning light to warn of the defective air distribution performance between the first fuel cell stack and the second fuel cell stack.

10. A method for determining air distribution performance of a fuel cell system, the method comprising:
determining, by a controller, a first absolute humidity of first air supplied to an air cut off valve disposed on a downstream side of an air compressor;
determining, by the controller, a second absolute humidity of second air supplied to a first fuel cell stack connected to the air cut off valve through a first air path;
determining, by the controller, a third absolute humidity of third air supplied to a second fuel cell stack connected to the air cut off valve through a second air path;
determining, by the controller, a ratio between a flow rate of the third air and a flow rate of the second air based on the first absolute humidity of the first air, the second absolute humidity of the second air, and the second absolute humidity of the third air; and
determining air distribution performance between the second fuel cell stack and the first fuel cell stack based on the ratio.

11. The method according to claim 10, wherein:
determining the first absolute humidity of the first air is based on a first dew point and a first pressure measured on an upstream side of the air cut off valve;
determining the second absolute humidity of the second air is based on a second dew point and a second pressure measured in the first air path; and
determining the third absolute humidity of the third air is based on a third dew point and a third pressure measured in the second air path.

12. The method according to claim 10, wherein determining the air distribution performance between the second fuel cell stack and the first fuel cell stack includes:
determining, when the ratio between the flow rate of the third air and the flow rate of the second air is equal to or greater than a set minimum value and is equal to or smaller than a set maximum value, that the air distribution performance between the first fuel cell stack and the second fuel cell stack is not defective; and
determining, when the ratio between the flow rate of the third air and the flow rate of the second air is smaller than the set minimum value or greater than the set maximum value, that the air distribution performance between the first fuel cell stack and the second fuel cell stack is defective.

13. The method according to claim 10 further comprising:
determining, by the controller, when a difference value between the flow rate of the second air and the flow rate of the third air is equal to or greater than a set threshold, that the air distribution performance between the first fuel cell stack and the second fuel cell stack is defective; and
determining, by the controller, when the difference value between the flow rate of the second air and the flow rate of the third air is smaller than the set threshold, that the air distribution performance between the first fuel cell stack and the second fuel cell stack is not defective.

14. The method according to claim 10, wherein the flow rate of the second air and the flow rate of the third air are determined based on the flow rate of the first air, the first absolute humidity, the second absolute humidity, and the third absolute humidity.

15. The method according to claim 10 further comprising in response to determining that the air distribution performance between the first fuel cell stack and the second fuel cell stack is defective, increasing, by the controller, the flow rate of the first air through the air compressor.

16. The method according to claim 15 further comprising:
after increasing the flow rate of the first air, re-determining, by the controller, a difference value between the flow rate of the second air and the flow rate of the third air; and
when the re-determined difference value is smaller than a threshold, determining, by the controller, that a cause of a defective air distribution performance between the first fuel cell stack and the second fuel cell stack is flooding that has occurred in at least one of the first fuel cell stack or the second fuel cell stack.

17. The method according to claim 16 further comprising:
determining, by the controller, when the re-determined difference value is equal to or greater than the threshold, that the cause of the defective air distribution performance between the first fuel cell stack and the second fuel cell stack is not the flooding.

18. The method according to claim 16 further comprising turning on, by the controller, when the re-determined difference value is equal to or greater than the threshold, a warning light to warn the defective air distribution performance between the first fuel cell stack and the second fuel cell stack.
